(19) United States
(12) Patent Application Publication
(10) Pub. No.: US 2006/0136882 A1
(43) Pub. Date: Jun. 22, 2006

(54) System and method for background JAVA application resource control

(75) Inventors: Lee Noonan, East Sussex (GB); Michael Rhodes, Winchester (GB)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/015,115

(22) Filed: Dec. 17, 2004

(51) Int. Cl. G06F 9/45

(52) U.S. Cl. 717/140

(57) ABSTRACT

A system and method for providing an indication regarding the operation of an electronic device. When a program operates in the background of the electronic device, the activity of the program is electronically monitored by the system. The system determines whether the activity of the program exceeds a threshold for at least one operating parameter of the electronic device. If the activity of the program exceeds the predetermined threshold, an indication is provided to a user regarding the activity of the program.

### FIELD OF THE INVENTION

The present invention relates generally to Java-based software programs. More particularly, the present invention relates to the resource administration of Java-based programs by the respective Java platform.

### BACKGROUND OF THE INVENTION

The Java 2 Platform, Micro Edition (J2ME) provides a robust and flexible environment for applications operating on devices such as mobile telephones, personal digital assistants (PDAs) and other electronic devices. The J2ME platform includes flexible user interfaces, a robust security model, a broad range of built-in network protocols, and other features.

In electronic devices, such as mobile telephones, that run off of the J2ME platform, system resources such as computer processing power, memory, and battery life are limited. These limitations are much more stringent on smaller, portable devices than on larger personal computers. Partially to address this issue, the current Series40 Java Software Component allows only one midlet to run at a time. A midlet is an application that runs on a mobile device. Furthermore, a midlet running on the J2ME platform must always run in the foreground. The term “foreground” refers to the idea that the midlet is exhibited on the device display and that, when a button or key is actuated, the stroke is routed to the midlet. Therefore, when a midlet is running, the user is able to observe that the system resources are being used by the midlet

Because current systems only permit one midlet to run at a time, the wasting of resources such as processing power and battery life are not significant issues. However, technology is being developed that will allow multiple midlets to operate on a system at the same time, and for the midlets to operate in the background of the system. The term “background” means that the midlet at issue is not exhibited on the display of the electronic device, and when a button or key is actuated, the stroke is not directed to the midlet. This feature permits a wide a variety of programs and features, such as third party messaging systems, electronic mail programs, etc. to be designed and implemented by third party developers, which therefore can provide many benefits to the end user.

Although beneficial, the possibility of multiple midlets running in the background presents a new set of potential issues. Third party, JAVA-based software often requires a significant amount of memory and processing power, which also results in the battery being drained more quickly than built-in programming. This may lead to other negative effects, such as causing the other applications in the device to run more slowly, preventing other applications from being started, and other problems.

The problems identified above are further exacerbated by the fact that, with the programs running in the background, a user may not even be fully cognizant of how many programs are actually running on the device. As the processing power, memory and battery life is diminished, a user may therefore not understand the cause of the problems, possibly misidentifying the device itself as the source of the problems instead of the third party software. Furthermore, these programs may continue to operate in the background even if the user does not wish them to be operating at a particular moment.

In addition to the above, A midlet that remains in the background and does not request to enter the foreground may be a perfectly valid midlet that is designed to behave in this way; it could be a midlet that the user has started and forgotten about; it could be a badly written midlet; or it could be a malicious midlet that is designed to drain resource or cause other problems. So long as the midlet remains in the background, however, the user is much less likely to even be aware of its existence.

### SUMMARY OF THE INVENTION

The present invention provides a system and method that monitors background midlets so that a user can be informed of their operation. Under the principles of the present invention, if a background midlet does not request to move to the foreground and the midlet's use of system resources exceeds a defined threshold, then the user is warned by the system that the midlet is running in the background. Once the user has noticed of the midlet's operation, the user may decide to terminate the midlet that caused the warning.

The present invention provides significant benefits to the user during the operation of the electronic device. With the present invention, the user has the increased opportunity to preserve system resources and to avoid negative effects such as having others application run more slowly, having other applications not being able to initiate their own operation, and losing battery life more quickly than is desired or necessary.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is a flow chart showing the implementation of one embodiment of the present invention; and

FIG. 4 is a representation of a display screen showing a menu for disabling the midlet warning feature of the present invention.

### DETAILED DESCRIPTION OF THE PREFERRED EMBODIMENTS

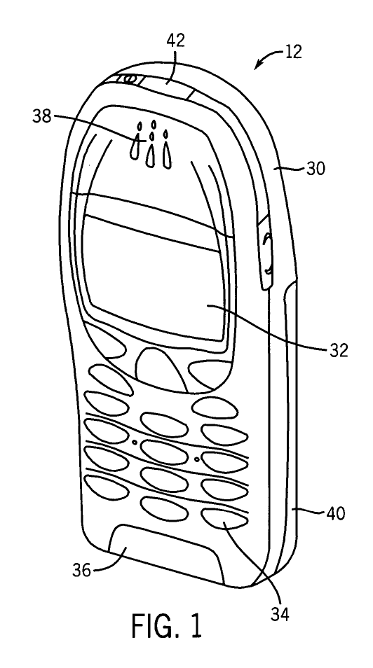

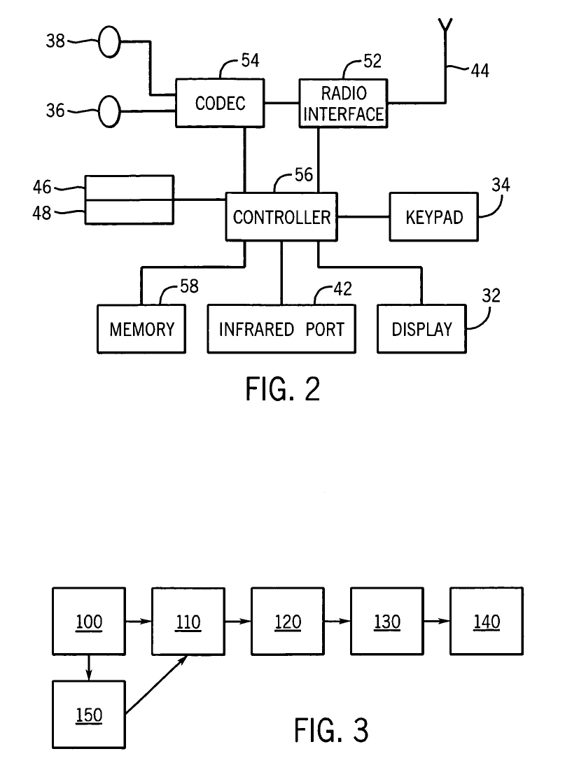

FIGS. 1 and 2 show one representative mobile telephone 12 upon which the present invention may be implemented. However, it is important to note that the present invention is not limited to any type of electronic device and could be incorporated into devices such as personal digital assistants, personal computers, and other devices. It should be understood that the present invention could be incorporated on a wide variety of mobile telephones 12. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. It should be noted that the controller 56 can be the same unit or a different unit than the camera processor 16. Individual circuits and elements are all of a type well known in the art, for example in the Nokia range of mobile telephones.

The present invention comprises a system and method of providing a notification to a user of a midlet operating in the background of the system that is consuming a predefined amount of resources and/or has been operating for a predetermined period of time. While embodiments of the invention are described in the context of midlets, it should be understood that embodiments of the invention are not limited to midlets but can also apply to other programs. For example, embodiments of the invention can apply to other third party applications installed on a mobile device, such as Symbian application or other JAVA profiles (such as Xlets or JAVA applications) for example.

The manner in which a user is warned about midlet programs can vary depending upon the design of the device being used, as well as the design of the user interface. In one embodiment of the invention, for example, the device may play a sound through the speaker and/or exhibit an icon, text, or graphics on the display to warn the user about a particular background midlet that has exceeded a certain resource threshold and/or has been operating for an excessive period of time. Another potential option is for the system to actuate a vibrator on the device so that the warning can be felt by the user.

There are several types of system resources that could be monitored by the system according to the principles of the present invention. In one embodiment of the invention, the threshold values and the actual resources that are monitored are system-specific. The following are examples of resources that can be monitored in order to trigger a warning according to the principles of the present invention. Other parameters than those described below can also be monitored and/or trigger a warning.

For the electronic device's central processing unit (CPU), the number of byte codes executed by a background midlet can be monitored by the system. Additionally, the Java methods that map to native system calls can be monitored as well. When a threshold value for either of these parameters is exceeded, the user is warned that the midlet is operating in the background.

For the electronic device's memory unit, the amount of Java heap or native memory consumed by the midlet could be monitored. When a threshold value for either of these parameters is exceeded, the user is warned that the midlet is operating in the background.

For a timer on the electronic device, the amount of time a background midlet remains in the background could also be monitored. When the background midlet has remained in the background beyond a predetermined period of time, then the user is warned that the midlet is operating in the background.

In addition to the above, it is also possible that the user can be warned when the battery is draining at a high rate due to the presence of background midlets. However, in many instances such an action would occur due to excessive demands on the CPU or memory, both of which are likely to result in independent warnings being provided to the user.

In one embodiment of the invention, the thresholds discussed above are based upon predetermined settings that are provided by the system or platform manufacturer. However, it is also possible to provide the user with advanced options for customizing these settings as desired.

Various types of information can be provided to the user when a warning is given. For example, but without limitation, the name of the midlet, the manufacture of the midlet program, the size of the midlet, the midlet application type, the amount of memory and/or processing power being used, the amount of time the midlet has been operating in the background, and other information can all be provided to the user when a warning or indication is provided.

FIG. 3 is a generic flow chart showing one method for the implementation of the present invention. At step 100, a midlet begins to operate in the background of the electronic device. At step 110, the electronic device begins to monitor the activity of the midlet. Although steps 100 and 110 are shown as being sequential, it should be understood that these two actions can occur substantially simultaneously. At step 120, the activity of the midlet passes a predesignated threshold. As mentioned above, the activity at issue can relate to functions dealing with the device memory, processing power, the amount of time the midlet has been operating in the background, or other functions. At step 130, the system provides an indication to the user regarding the activity of the midlet. At step 140, at the user's option, the user can disable the midlet if desired.

In some situations, a midlet (either preinstalled or downloaded with the necessary permissions, may, by default, have the resource control set to OFF. In this situation, the user may or may not have the option to turn the resource control ON for these midlets.

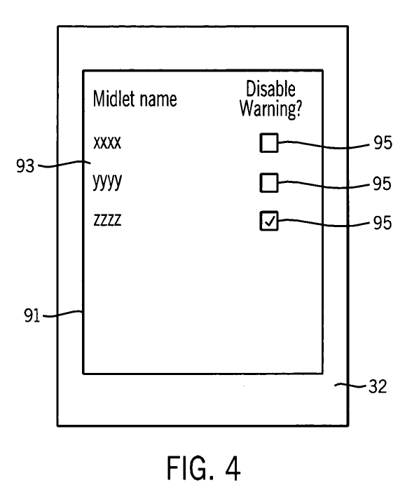

Also, depending upon the situation, there will be many situations where a perfectly valid midlet is designed to run in the background for long periods of time. In many instances, such a midlet will either not be a significant drain on system resource or will be a midlet which the user wishes to continue operating in the background. In such a situation, the user may not want to be warned about the midlet. For this scenario, the present invention can include a mechanism in which an option is provided to the user to disable the background midlet resource monitoring on a per midlet basis. A generic representation of such an option is depicted in FIG. 4. In this example, the system can provide the user with a menu 91 on the display 32 that provides a list 93 of all midlets that are detected on the device, with check boxes 95 being used to identify those midlets for which a warning should or should not be presented. This particular option is represented at step 150 in FIG. 3 and, in one embodiment of the invention, can be implemented either when a midlet is running or not running.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing a indication regarding the operation of an electronic device, the method comprising:
having a program operate in the background of the electronic device;
monitoring the activity of the program;
determining whether the activity of the program exceeds a predetermined threshold for at least one operating parameter;
if the activity of the program exceeds the predetermined threshold, providing an indication to a user regarding the activity of the program.

2. The method of claim 1, further comprising the step of providing the user with an option to terminate the program after receiving the indication.

3. The method of claim 1, wherein the indication is provided to the user in visual form.

4. The method of claim 1, wherein the indication is provided to the user in audible form.

5. The method of claim 1, wherein the at least one operating parameter is related to use of a memory unit within the electronic device.

6. The method of claim 1, wherein the at least one operating parameter is related to use of a processor within the electronic device.

7. The method of claim 1, wherein the at least one operating parameter is related to use of an energy source within the electronic device.

8. The method of claim 1, wherein the at least one operating parameter comprises an amount of time that the program remains in the background.

9. The method of claim 1, further comprising the step of enabling the user to manually set the threshold.

10. The method of claim 1, further comprising the step of enabling the user to selectively deactivate the providing of the indication.

11. A computer program product for providing an indication regarding the operation of an electronic device, the computer code product comprising:
computer code for having a program operate in the background of the electronic device;
computer code for monitoring the activity of the program;
computer code for determining whether the activity of the program exceeds a predetermined threshold for at least one operating parameter;
computer code for, if the activity of the program exceeds the predetermined threshold, providing an indication to a user regarding the activity of the program.

12. The computer program product of claim 11, further comprising computer code for providing the user with an option to terminate the program after receiving the indication.

13. The computer program product of claim 11, wherein the indication is provided to the user in visual form.

14. The computer program product of claim 11, wherein the indication is provided to the user in audible form.

15. The computer program product of claim 11, wherein the at least one operating parameter is related to use of a memory unit within the electronic device.

16. The computer program product of claim 11, wherein the at least one operating parameter is related to use of a processor within the electronic device.

17. The computer program product of claim 11, wherein the at least one operating parameter is related to use of an energy source within the electronic device.

18. The computer program product of claim 11, wherein the at least one operating parameter comprises an amount of time that the program remains in the background.

19. The computer program product of claim 11, further comprising computer code for enabling the user to manually set the threshold.

20. The computer program product of claim 11, further comprising computer code for enabling the user to selectively deactivate the providing of the indication.

21. An electronic device, comprising:
a processor for processing information; and
a memory unit for storing information to be processed by the processor, the memory unit including a computer program product comprising:
computer code for having a program operate in the background of the electronic device;
computer code for monitoring the activity of the program;
computer code for determining whether the activity of the program exceeds a predetermined threshold for at least one operating parameter;
computer code for, if the activity of the program exceeds the predetermined threshold, providing an indication to a user regarding the activity of the program.

22. The electronic device of claim 21, wherein the computer program product further comprises computer code for providing the user with an option to terminate the program after receiving the indication.

23. The electronic device of claim 21, wherein the indication is provided to the user on a display operatively connected to the processor.

24. The electronic device of claim 21, wherein the indication is provided to the user through a speaker operatively connected to the processor.

25. The electronic device of claim 21, wherein the at least one operating parameter is related to use of a memory unit.

26. The electronic device of claim 21, wherein the at least one operating parameter is related to use of the processor.

27. The electronic device of claim 21, wherein the at least one operating parameter is related to use of an energy source within the electronic device.

28. The electronic device of claim 21, wherein the at least one operating parameter comprises an amount of time that the program remains in the background.

29. The electronic device of claim 21, wherein the computer program product further comprises computer code for enabling the user to manually set the threshold.

30. The electronic device of claim 21, wherein the computer program product further comprises computer code for enabling the user to selectively deactivate the providing of the indication.

31. The electronic device of claim 21, wherein the program comprises a Java midlet.
